(19) United States
(12) Patent Application Publication
(10) Pub. No.: US 2013/0003722 A1
(43) Pub. Date: Jan. 3, 2013

(54) VOICE COMMUNICATION OF DIGITS

(75) Inventors: Jayakumar Balaji, Guindy (IN); Balasubramanian Gopalasubramanian, Guindy (IN); Nainar Mahalakshmi, Guindy (IN)

(73) Assignee: ALCATEL LUCENT, Paris (FR)

(21) Appl. No.: 13/522,166

(22) PCT Filed: Jul. 15, 2010
(86) PCT No.: PCT/EP10/60252

§ 371 Date: Sep. 6, 2012

(30) Foreign Application Priority Data
Mar. 9, 2010 (IN) 623/CHE/2010

(51) Int. Cl. H04L 12/66

(52) U.S. Cl. 370/352

(57) ABSTRACT

The present invention relates to SIP networks and, more particularly, to digit collection in SIP networks. The SIP user communicates the digits to a Media Server through voice/speech. The Media Server collects the digits and checks to determine if the digits satisfy required Dual Tone Multi Frequency rules. The Media Server plays a prompt message to the SIP user to indicate start of session to collect the digits and the SEP user says character(s) to indicate that the SIP user has completed saying the digits.

### TECHNICAL FIELD

The present invention relates to SIP networks and, more particularly, to digit collection in SIP networks.

### BACKGROUND

While using network resources in a communication network, a user may sometimes have to enter digits using a communication terminal. The entered digits may be used to invoke some services, enter user id, password, destination number or any other requirement wherein dialing of digits is a prerequisite. For example, to invoke the calling card feature, the user may have to enter the service code before availing of the feature. The user enters the digits after ensuring that all Dual Tone Multi Frequency (DTMF) rules have been complied with while entering the digits. The user dials the end of digit key to indicate that the user has completed dialing the digits. Once the user enters the number, the network checks to determine if the user has complied with the required DTMF rules while entering the digits.

However, in Session Initiation Protocol (SIP) Networks, the user does not have other options to enter the digits, instead of dialing the digits. Some users may find it difficult to dial the digits. For example, SIP users having some problem with their vision would prefer saying the digits. SIP users suffering from other medical conditions, such as arthritis, would also not prefer having to dial the digits. Hence, such SIP users need other ways to communicate digits to the network. Also, any SIP user who wishes to communicate the digits in some other way does not have the option of choosing the mode of communication of digits to the network. Current systems allow voice to be detected by the SIP network; however there is no provision for collecting digits from the SIP user, through voice, and verifying that the SIP user has complied with the required DTMF rules while entering the digits.

### SUMMARY

In view of the foregoing, an embodiment herein provides a method for collecting digits from a SIP user, in a communication network. The SIP user communicates the digits to a Media Server through voice/speech. The Media Server collects the digits and checks to determine if the digits satisfy required Dual Tone Multi Frequency rules. The SIP user communicates the digits to the Media Server using a communication terminal. The Media Server plays a prompt message to the SIP user to indicate start of session to collect the digits and the SIP user says at least one character to indicate that the SIP user has completed saying the digits. The Media Server sends the result of the check to a Service Control Point (SCP) through a Media Gateway Controller. A voiceinformation parameter is included in a Media Server Markup Language (MSML)/Media Server Control Interactive Voice Response (MSCIVR) format in a SIP INFO message sent to the Media Server, wherein the parameter indicates that the digit collection would happen through voice. The Dual Tone Multi Frequency rules comprise at least one of minimum number of digits to be collected, maximum number of digits to be collected, at least one character to indicate that the SIP user has completed saying the digits, start of digit indicator, cancel digit, timer value to be used between start of digit collection session until the first digit is collected and timer value to be used between two consecutive digits.

Embodiments further disclose a Media Server for collecting digits from a SIP user, in a communication network. The Media Server collects the digits spoken by the SIP user and checks the digits to determine if the digits satisfy required Dual Tone Multi Frequency rules. The Media Server plays a prompt message to the SIP user to indicate start of session to collect the digits. The Media Server stops collecting the digits when the SIP user says at least one character to indicate that the SIP user has completed saying the digits. The Media Server sends the result of the check to a Service Control Point (SCP) through a Media Gateway Controller. The Dual Tone Multi Frequency rules comprise at least one of minimum number of digits to be collected, maximum number of digits to be collected, at least one character to indicate that the SIP user has completed saying the digits, start of digit indicator, cancel digit, timer value to be used between start of digit collection session until the first digit is collected and timer value to be used between two consecutive digits.

Embodiments herein also disclose a method for collecting digits from a SIP user, in a communication network. The SIP user communicates the digits to a Media Server through voice/speech. The SIP user communicates the digits to the Media Server using a communication terminal.

Also, disclosed herein is a Media Server for collecting digits from a SIP user, in a communication network. The Media Server collects the digits spoken by the SIP user. The SIP user communicates the digits to the Media Server using a communication terminal.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a block diagram of a SIP user in a communication network, according to an embodiment herein;

FIG. 2 illustrates a block diagram of a Media Server, according to an embodiment herein;

FIGS. 3a and 3b are a flowchart depicting a method for collecting digits through voice/speech and checking for DTMF rules, according to an embodiment herein;

FIG. 4 illustrates a flow diagram for an example showing digit collection through voice/speech and checking for DTMF rules, according to an embodiment herein;

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

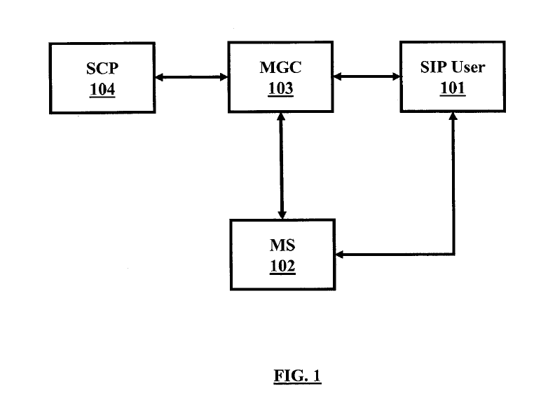

The embodiments herein disclose a method and system for collecting digits from a SIP user through voice and checking if the collected voice digits satisfy the required DTMF rules. Referring now to the drawings, and more particularly to FIGS. 1 through 4, where similar reference characters denote corresponding features consistently throughout the figures, there are shown embodiments.

FIG. 1 illustrates a block diagram of a SIP user in a communication network. In a communication network, a SIP user 101 may have to communicate the digits of a number to a Media Server (MS) 102. For example, the SIP user 101 may have to enter a user id and password in order to avail of the phone banking feature made available by banks. The MS 102 is a server that helps establish and maintain a multi media session with SIP user 101. The MS 102 also stores media and shares the stored media with users of the network. Before communicating the digits by voice, the SIP user 101 initiates a communication link with the network. The SIP user 101 may initiate the communication link by sending a request to a Media Gateway Controller (MGC) 103. The MGC 103 receives signaling information from the MS 102 and instructs the MS 102 to alert the destination in order to start a communication session between the calling user and the destination. The destination may be a second SIP user with whom the calling user wishes to communicate with. The MGC 103 also acts as a Service Switching Point (SSP) and makes available additional services during a communication session. In other embodiments, the SSP may be a network element located outside the MGC 103. On receiving the request, from the SIP user 101, and on determining that digits have to be collected from the SIP user 101, the MGC 103 triggers a Service Control Point (SCP) 104. The SCP 104 contains the service logic that implements the services related to collection of the digits using voice required by the SIP user 101. The SCP 104 sends a prompt announcement to the MS 102 and instructs the MS that digit collection would be happening through voice signals. For example, the SCP 104 may send a Prompt and Collect User Information (PACUI) to the MS 102. The PACUI is used to play a prompt announcement and collect digits from the SIP user 101. The SCP 104 may also include Dual Tone Multi Frequency (DTMF) rules in the PACUI, to be checked by the MS 102. The DTMF rules and information included in the PACUI may be the minimum and maximum number of digits to be collected, the character/digit used to indicate the end of digit collection, a start of digits indicator, a cancel digit to allow the SIP user 101 to cancel the spoken digits and restart the digit collection session, the timer value to be used between start of digit collection session until the first digit is obtained from the SIP user 101, the timer value to be used between two consecutive digits and any other rule that has to be followed by the user while saying the digits. The MS 102 plays the prompt announcement received from the SCP 104 to the SIP user 101. For example, the prompt announcement may be “Say your user id and say hash to end the transmission”.

The SIP user 101 may communicate the digits through voice/speech using a communication terminal. For example, the communication terminal may be a SIP terminal. After saying the digits, the SIP user 101 says the character to end the digit collection session with the MS 102. For example, SIP User 101 may say hash to indicate the end of digit collection session. SIP user 101 may start saying the digits before the end of the prompt announcement or after the end of the prompt announcement. The SCP 104 may specify a parameter in the message sent to the MGC 103 to indicate if SIP user 101 can say the digits before the end of the prompt announcement. For example, a parameter “barge=true” may be set to indicate that SIP user 101 can start saying the digits before the end of the prompt announcement. If SIP user 101 starts saying the digits before the end of the prompt announcement, then the MS 102 stops playing the prompt announcement and starts collecting the digits. The parameter “barge=false” may be set to indicate that SIP user 101 cannot start saying the digits before the end of the prompt announcement. The MS 102 does not start collecting the digits until the end of the prompt announcement. The MS 102 collects the voice digits obtained from the SIP user 101. After collecting the voice digits from the SIP user 101, the MS 102 converts voice samples to digits and checks to see if the SIP user 101 has followed all DTMF rules while communicating the digits. For example, the MS 102 may covert the voice sample to digits through analog-to-digital conversion. In a second example, if SIP user 101 says zero to indicate that SIP user has completed saying the digits, then the word “zero” would be converted to the digit “0” by the MS 102. In another example, if SIP user 101 is prompted as “Say yes to forward call” and if the code for call forwarding is 3, then the MS 102 converts “yes” to “3” when SIP user 101 says “yes”. If the MS 102 determines that all DTMF rules have been followed by the collected voice digits, then the MS 102 sends a response to the MGC 103 indicating successful collection of digits and also sends the collected digits to the MGC 103. If the MS 102 determines any error in the collected voice digits, then the MS 102 sends a response to the MGC 103 indicating error in collection of digits. For example, an error could occur if any DTMF rule was violated by the SIP user 101, while saying the digits or if the SIP user 101 typed the digits instead of saying it. If the minimum number of digits to be entered by SIP user 101 is 5 and if SIP user 101 enters only 3 digits, then the DTMF rule is violated. If the allowed time gap between the entry of two consecutive digits is 5 seconds and if the user does not enter the second digit within 5 seconds from the time of entry of the first digit, then DTMF rule is violated. The MGC 103 forwards the response received from the MS 102 to the SCP 104.

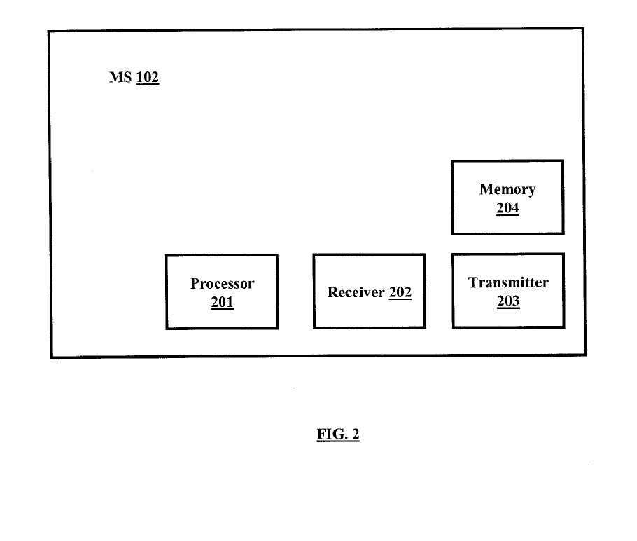

FIG. 2 illustrates a block diagram of a Media Server (MS). The MS 102 is a server that helps establish and maintain a multi media session with the SIP user 101. In a communication network, a SIP user 101 may have to communicate the digits of a number to the MS 102. If the SIP user 101 chooses to communicate the digits through voice, then the SIP user 101 can say the digits using a communication terminal. After saying the digits, the SIP user 101 says the character to end digit collection session with the MS 102. The MS 102 collects the voice digits obtained from the SIP user 101 using a receiver 202. The collection of voice digits by the MS 102 may be provided in all Intelligent Network Application Part (INAP) and Customized Applications for Mobile Network Enhanced Logic (CAMEL) architectures. The MS 102 may also collect voice digits when the SIP user 101 wants to avail of supplementary features provided by the MGC 103. For example, supplementary features provided by the MGC 103 may be Call Forwarding, Call Waiting and Outgoing Call Barring features. After collecting the voice digits from the ST user 101, the processor 201 converts voice samples to digits and checks to see if the SIP user 101 has followed all DTMF rules while communicating the digits. For example, a DTMF rule may state that the minimum number of digits to be entered by the SIP user 101 as 10 and if SIP user 101 enters 8 digits then the DTMF rule is violated and an error occurs. If the processor 201 determines that all DTMF rules have been followed by the collected voice digits, then the processor 201 sends a response to the MGC 103 using a transmitter 203 indicating successful collection of digits and also sends the collected digits to the MGC 103. The collected digits are sent to the MGC 103 using a transmitter 203. If the processor 201 determines any error in the collected voice digits, then the processor 201 sends a response to the SCP 104 through the MGC 103 indicating error in collection of digits. If any error is detected in the collected voice digits, then SIP user 101 may be allowed to say the digits once again. The communication between the MS 102 and MGC 103 may happen using SIP signaling

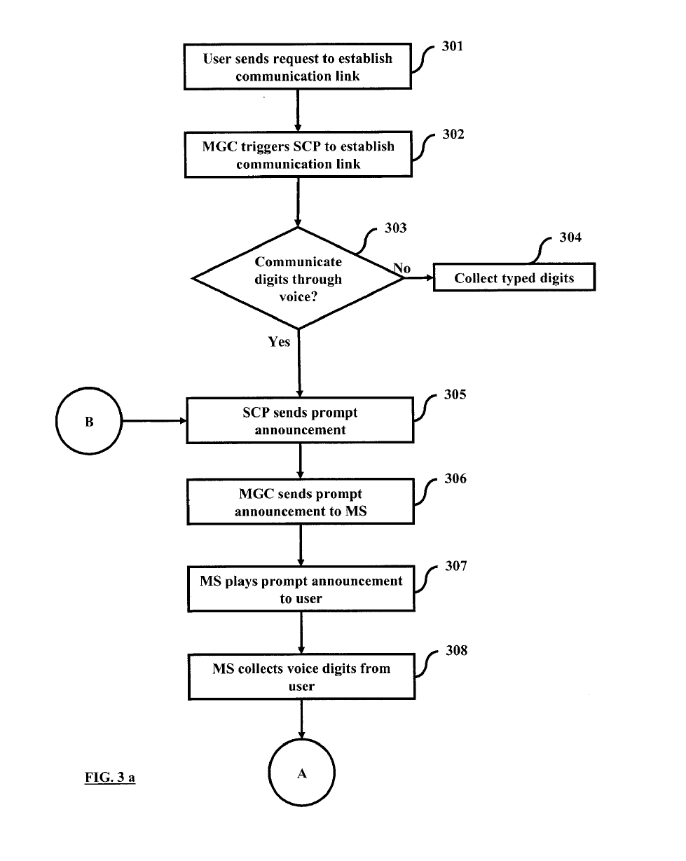

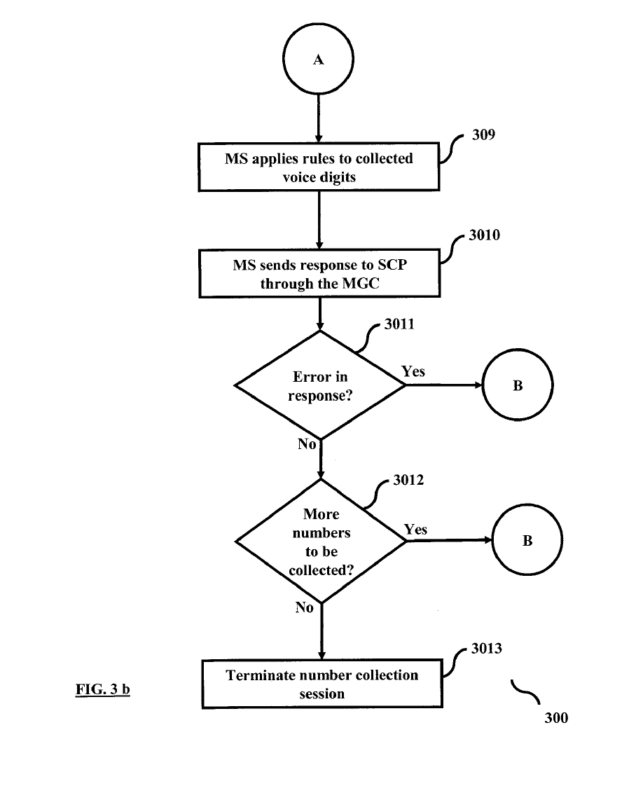

FIGS. 3a and 3b are a flowchart depicting a method for collecting digits through voice/speech and checking for DTMF rules. In a communication network, a SIP user 101 may have to communicate the digits of a number to the MS 102. Before communicating the voice digits, the SIP user 101 initiates (301) a communication link with the network. The SIP user 101 may initiate the communication link by sending a request to the MGC 103. On receiving the request, from the SIP user 101 the MGC 103 triggers (302) the SCP 104 to establish a communication link. If SIP user 101 chooses to communicate (303) the digits by typing the digits, then the MS collects (304) the typed digits using a suitable means. For example, SIP user 101 may choose to communicate the digits by typing the digits by entering a service code, such as 800. If the user chooses to communicate (303) the digits through voice, then SCP 104 sends (305) a prompt announcement to the MS 102 and instructs the MS that digit collection would be happening through voice signals. For example, SIP user 101 may choose to communicate the digits through voice by entering a service code, such as 801. In a second example, the SCP 104 may send a PACUI to SIP user 101 to determine if SIP user 101 wishes to communicate the digits through voice or by typing the digits. The PACUI may have a prompt announcement as “Enter 1 to provide information through voice or enter 2 to type the information”. The prompt announcement is sent to be played to the user and the SCP 104 also sends the DTMF rules that have to be followed by the SIP user 101 while saying the digits. The MGC 103 receives the prompt announcement from the SCP 104 and sends (306) the prompt announcement to the MS 102. The MS 102 plays (307) the prompt announcement to the SIP user 101. For example, the prompt announcement played to the user may be “Tell your calling card number and say hash to end”.

The SIP user 101 may communicate the digits through voice/speech using a communication terminal and after saying the digits; SIP user 101 says the character to end digit collection session with the MS 102. The MS 102 collects (308) the digits in the form of voice from SIP user 101. After collecting the voice digits from SIP user 101, the MS 102 converts the voice samples to digits and checks (309) to see if SIP user 101 has followed all DTMF rules while communicating the digits. If the MS 102 determines that all DTMF rules have been followed by the collected voice digits, then the MS 102 sends (3010) a response to the SCP 104, through the MGC 103, indicating successful collection of digits and also sends the collected digits to the SCP 104, through the MGC 103. If the MS 102 determines any error in the collected voice digits, then the MS 102 sends (3010) a response to the SCP 104, through the MGC 103, indicating error in collection of digits. If the response from the MS 102 indicates an error (3011) in the received digits, then the SCP 104 may restart digit collection session with the SIP user 101. If the response from the MS 102 indicates there was no error in the received digits, then the SCP 104 further processes the received digits. For example, if the received number was a password, then the SCP 104 further processes the password to determine if the received password was the valid password. If there are more numbers to be collected (3012) from the SIP user 104, then the SCP 104 starts a digit collection session to obtain the numbers from the SIP user 104. If there are no more numbers to be collected (3012) from the SIP user 104, then the SCP 104 (3012) ends digit collection session. The various actions in method 300 may be performed in the order presented, in a different order or simultaneously. Further, in some embodiments, some actions listed in FIG. 3 may be omitted.

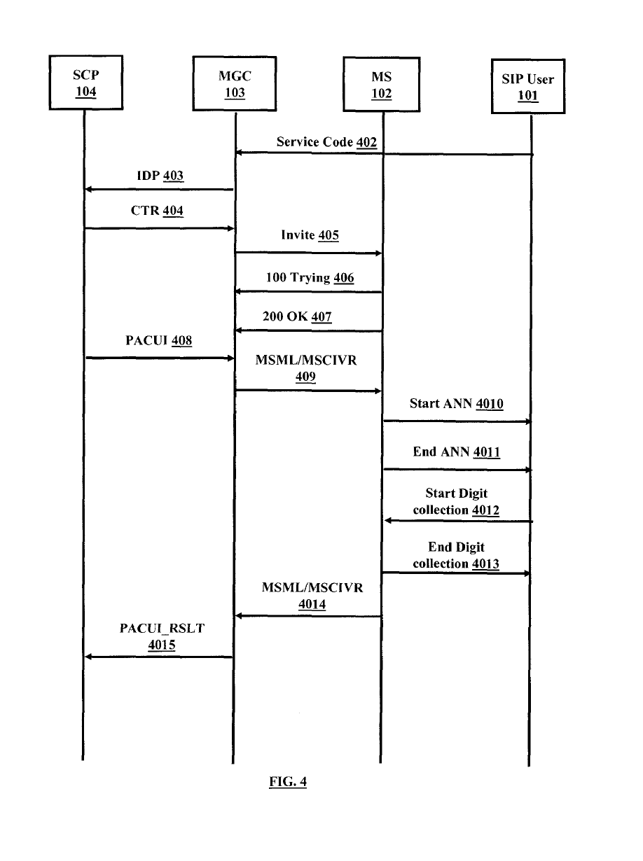

FIG. 4 illustrates a flow diagram for an example showing digit collection through voice/speech and checking for DTMF rules. In a communication network, a SIP user 101 may have to communicate the digits of a number to the MS 102. For example, the SIP user 101 may want to avail of calling card feature, wherein the SIP user 101 can make calls using a calling card, and needs to communicate a user id before availing the feature. Before communicating the voice digits, the SIP user 101 initiates a communication link with the network and chooses to communicate the digits through voice. The SIP user 101 may initiate the communication link by sending a request to the MGC 103. For example, to avail of calling card feature the SIP user 101 may send a Service code 402 to the MGC 104. On receiving the request, from the SIP user 101, and on determining that digits have to be collected from the SIP user 101, the MGC 103 triggers the SCP 104. For example, the MGC 103 may trigger the SCP 104 by sending an Initial Detection Point (IDP) 403 to the SCP 104. On being triggered, the SCP 104 instructs the MS 102, using the MGC 103, to start a communication session with the SIP user 101. The SCP 104 sends a message to the MS 102, through the MGC 103, to instruct the MS 102. For example, the SCP 104 may send a Connect to Resource (CTR) 404 message to the MGC 103 and the MGC 103 may send an Invite 405 message to the MS 102. The MS 102 then tries to establish a communication session with SIP user 101 and sends a message to the MGC 103 indicating that the MS 102 is trying to establish a communication session with SIP user 101. For example, the message sent by the MS 102 to the MGC 103 may be a 100 Trying 406 message. On successfully establishing a session with SIP user 101, the MS 102 sends a message to the MGC 103 indicating the successful establishment of the session. For example, the MS 102 may send a 200 OK 407 message to the MGC 103 indicating the successful establishment of the session and the communication between the MS 102 and SIP user 101 may happen through Real-time Transport Protocol (RTP). The SCP 104 sends a prompt announcement to the MS 102, through the MGC 103, and instructs the MS that digit collection would be happening through voice signals. The SCP 104 also sends the DTMF rules to the MS 102. For example, the SCP 104 may send the prompt announcement as a PACUI 408 to the MGC 103 and have a parameter in the PACUI 408 message indicating that digit communication by SIP user 101 would happen through voice/speech. The MGC 103 sends the prompt announcement and the DTMF rules to the MS 102. For example, the MGC 103 may send the prompt announcement and the DTMF rules as a Media Server Markup Language (MSML)/Media Server Control Interactive Voice Response (MSCIVR) 409 in the SIP INFO message. The SIP info message may also indicate to the MS 102 that digit collection would happen through voice. A voiceinformation parameter in the MSML/MSCIVR 409 message may be used to indicate to the MS 102 that digit collection would happen through voice.

The MS 102 then plays the prompt message to the SIP user 101. For example, the prompt message may start as a Start Ann 4010 message and end as an End Ann 4011 message. The MS 102 collects the voice digits obtained from the SIP user 101. For example, the MS 102 may start digit collection as Start digit collection 4012. After saying the digits, the SIP user 101 says the character to end digit collection session with the MS 102 and on receiving the end of session character, the MS 102 stops digit collection session. For example, the MS 102 may stop digit collection as End digit collection 4013. After collecting the voice digits from the SIP user 101, the MS 102 converts voice samples to digits and checks to see if SIP user 101 has followed all DTMF rules while communicating the digits. If the MS 102 determines that all DTMF rules have been followed by the collected voice digits, then the MS 102 sends a response to the MGC 103 indicating successful collection of digits and also sends the collected digits to the MGC 103. If the MS 102 determines any error in the collected voice digits, then the MS 102 sends a response to the MGC 103 indicating error in collection of digits. For example, the MS 102 may send the response to the MGC 103 as a MSML/MSCIVR 4014 message. The MGC 103 sends the response, obtained from the MS 102, to the SCP 104. If the response sent is a successful response, then the MGC 103 also sends the collected digits to the SCP 104. For example, the response sent to the SCP 104 may be sent as a PACUI_RSLT 4015 message.

An example of the use of voice collection of digits through voice is in a calling card scenario. While availing of the calling card feature the SIP use 101 may have to communicate the user-id, pin number and the destination number. The SCP 104 first sends a PACUI to play a prompt announcement and collect the user-id through voice. The prompt announcement played may be “Tell your user-id and say hash to end”. The SCP 104 then sends a PACUI to play a prompt announcement and collect the pin number through voice. The prompt announcement played may be “Tell your pin number and say zero to end”. The SCP 104 finally sends a PACUI to play a prompt announcement and collect the destination number through voice. The prompt announcement played may be “Tell your destination number and say hash to end”. In other embodiments, some numbers may be collected trough voice and some numbers may be typed by the SIP user 101. For example, in the calling card scenario, SIP user 101 may say user-id through voice and enter the pin number and destination number by typing the numbers.

The embodiments disclosed herein can be implemented through at least one software program running on at least one hardware device and performing network management functions to control the network elements. The network elements shown in FIG. 1 and FIG. 2 include blocks which can be at least one of a hardware device, or a combination of hardware device and software module.

The embodiment disclosed herein specifies a system and method for collecting digits through voice/speech and check if the collected digits follow the required DTMF rules. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) or another coding language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an

FPGA, or at least one microprocessor and at least one memory with software modules located therein. The method embodiments described herein could be implemented in pure hardware or partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for collecting digits from a SIP user, in a communication network, said method comprising steps of
said SIP user communicating said digits to a Media Server (102) through voice;
said Media Server (102) collecting said digits; and
said Media server (102) checking to determine if said digits satisfy required Dual Tone Multi Frequency rules.

2. The method, as claimed in claim 1, wherein said SIP user communicates said digits to said Media Server (102) using a communication terminal.

3. The method, as claimed in claim 1, wherein said Media Server (102) plays a prompt message to said SIP user to indicate start of session to collect said digits.

4. The method, as claimed in claim 1, wherein said SIP user says at least one character to indicate that said SIP user has completed saying said digits.

5. The method, as claimed in claim 1, wherein said Media Server (102) sends result of said check to a Service Control Point (SCP) 104 through a Media Gateway Controller (103).

6. The method, as claimed in claim 1, wherein a voiceinformation parameter is included in a Media Server Markup Language (MSML)/Media Server Control Interactive Voice Response (MSCIVR) format in a SIP INFO message sent to said Media Server (102), wherein said parameter indicates that said digit collection would happen through voice.

7. The method, as claimed in claim 1, wherein said Dual Tone Multi Frequency rules comprise at least one of:
minimum number of digits to be collected;
maximum number of digits to be collected;
at least one character to indicate that said SIP user has completed saying said digits;
start of digit indicator;
cancel digit;
timer value to be used between start of digit collection session until the first digit is collected; and
timer value to be used between two consecutive digits.

8. A Media Server (102) for collecting digits from a SIP user, in a communication network, said Media Server (102) comprising at least one means adapted for:
collecting said digits spoken by said SIP user;
checking said digits to determine if said digits satisfy required Dual Tone Multi Frequency rules.

9. The Media Server (102), as claimed in claim 8, wherein said Media Server (102) is adapted to play a prompt message to said SIP user to indicate start of session to collect said digits.

10. The Media Server (102), as claimed in claim 8, wherein said Media Server (102) is adapted to stop collecting said digits when said SIP user says at least one character to indicate that said SEP user has completed saying said digits.

11. The Media Server (102), as claimed in claim 8, wherein said Media Server (102) is adapted to sends result of said check to a Service Control Point (SCP) 104 through a Media Gateway Controller (103).

12. The Media Server (102), as claimed in claim 8, wherein said Dual Tone Multi Frequency rules comprise at least one of:
minimum number of digits to be collected;
maximum number of digits to be collected;
at least one character to indicate that said SIP user has completed saying said digits;
start of digit indicator;
cancel digit;
timer value to be used between start of digit collection session until the first digit is collected; and
timer value to be used between two consecutive digits.

13. A method for collecting digits from a SIP user, in a communication network, said method comprising of said SIP user communicating said digits to a Media Server (102) through voice/speech.

14. The method, as claimed in claim 13, wherein said SIP user communicates said digits to said Media Server (102) using a communication terminal.

15. A Media Server (102) for collecting digits from a SIP user, in a communication network, said Media Server (102) comprising at least one means adapted for
collecting said digits spoken by said SIP user.

16. The Media Server (102), as claimed in claim 15, wherein said SIP user communicates said digits to said Media Server (102) using a communication terminal.
